(19) United States
(12) Patent Application Publication
(10) Pub. No.: US 2015/0369124 A1
(43) Pub. Date: Dec. 24, 2015

(54) HEAT ENGINE OPERATING IN ACCORDANCE WITH CARNOT'S THERMODYNAMIC CYCLE AND CONTROL PROCESS

(71) Applicants: Zulmira Teresina IOCKHECK, Curitiba - PR, CEP: (BR); ABX ENERGIA LTDA, Curitiba (BR)

(72) Inventor: Marino IOCKHECK, Curitiba (BR)

(73) Assignee: ABX ENERGIA LTDA, Curitiba (BR)

(21) Appl. No.: 14/410,105

(22) PCT Filed: Jun. 21, 2013
(86) PCT No.: PCT/BR2013/000222

§ 371 Date: Dec. 22, 2014

(30) Foreign Application Priority Data
Jun. 25, 2012 (BR) BR1020120155540

(51) Int. Cl. F02C 3/16; F02C 5/06

(52) U.S. Cl. CPC F02C 3/165; F02C 5/06

(57) ABSTRACT

“THERMAL MACHINE OPERATING PURSUANT TO CARNOT THERMODYNAMIC CYCLE AND PROCESS CONTROL” refers to the present invention, to a “Machine that operates in accordance with the Carnot thermodynamic cycle” which, according to its general characteristics, has as basic principle of converting thermal energy into driving force in the driving force element, typically an engine or turbine. The system consists of a body with two chambers forming two stators with concentric rotor and shaft, independently of the driving force element, both carry out the four thermodynamic cycle transformations, two isotherms transformations and two differentially adiabatic. This machine has computer program logic, a set of sensors connected to an electronic unit, which executes a process that has four thermodynamic transformations according to the Carnot cycle.

Refers to the present invention, the technical field of thermodynamic engines, and more specifically to a thermal engine which operates in accordance with the THERMODYNAMIC CARNOT CYCLE and control process which, according to its general characteristics, has as basic principle converting thermal energy into driving force in an engine, turbine or other driving force element.

The world needs are increasingly bruising regarding the power supply, the search for economically viable alternatives and relatively harmless or little offensive against nature is being researched by most countries, especially the most developed.

Various thermal engines have been invented in the last two hundred years for use in industry and to generate energy for the population, the most popular technologies and economically viable to date are:

Machines used in power plants, most operate by Rankine cycle, created in 1859 by William John Macquorn Rankine, uses as energy source basically fossil materials, coal and natural gas combustion is external. Four stages thermodynamic transformation, two adiabatic transformations and two isobaric transformations, and one more state transformation where water changes from liquid to vapor. Its yield is approximately 20 to 30%.

Machines used in jets operate by Brayton cycle, created in 1872 by George Brayton, proposed earlier in 1791 by John Barber, and uses as an energy source, also derived from fossil materials, kerosene, gas, combustion is internal. Four stages thermodynamic transformation, two adiabatic transformations and two isobaric transformations. Its yield is approximately 17% for gas turbines, applied in power generation.

Internal combustion engines used in automobiles operate by Otto cycle, developed by Nikolaus Otto in 1876, also uses fossil fuels, gasoline, currently also fossil origin, alcohol. It is a four-stages thermodynamic transformation machine with two adiabatic transformations and two isochoric. Its yield is approximately 26%.

Internal combustion machines used in heavy vehicles, trucks, trains, ships and industrial applications, operating the Diesel cycle, developed by Rudolf Diesel in 1893, also uses fossil fuels, diesel oil, now also of plant origin, biodiesel. It is a four-stages thermodynamic transformation machine with two adiabatic transformations, one isobaric transformation and other isochoric transformation. Its yield is approximately 34%.

External combustion machines, currently used in projects of alternative energy, operate at Stirling cycle, developed by Robert Stirling in 1816, using various sources of energy, currently focused on cleaner sources with a lower environmental impact, such as biomass, hot springs, thermo-solar. It is a four-stages thermodynamic transformation machine with two isothermal transformations and two isochoric transformations. Its yield is approximately 40 to 45%, varying according to the value and the temperature differential from hot and cold sources.

With the concept of Stirling, there are Alfa type engines such as those published in patents U.S. Pat. No. 7,827,789 and US20080282693, Beta type as the patent US20100095668, Gamma type as the patent US20110005220, Rotary Stirling machines such as U.S. Pat. No. 6,195,992 and U.S. Pat. No. 6,996,983 patent, Wankel-Stirling type hybrid as U.S. Pat. No. 7,549,289. All comprise the solidarity of the drive force cycle with the thermodynamic cycle and by its mechanical and process characteristics, do not perform adiabatic transformations.

Even with the Stirling concept, with two thermodynamic isothermic transformations and two isochoric transformations, patent PI1000624-9 of the same author is observed, which has differently from aforementioned the independent driving element of the thermodynamic cycle.

The last presented in this text is the Carnot machine, created by the French scientist, Nicolas Leonard Sadi Carnot, in 1824. It is an ideal machine, all other machines developed have their standard of performance and economic viability compared to the ideal Carnot machine. The Carnot machine operates in accordance with the thermodynamic cycle, which bears the same name, Carnot cycle, which presents two stages with isothermal transformation and two stages with adiabatic transformation. Exhaustively published literatures describe: isothermal stages, in which work is performed, one of them with gas expansion and the other one with gas contraction, where by the Carnot statement gas temperature should remain constant, but physically with gas expansion, its characteristic of thermal conductivity and machines' geometry makes this stage extremely difficult to be mechanically achieved, especially considering that there should be instant and sequential form exchange of these four transformations in the process. The adiabatic transformations, by Carnot statement, requires to be instantly removed the sources of heat or cooling subject to the working gas and keep it under expansion or compression within a thermally isolated volume, no supplying or removal of energy from environment, but to mechanically creating a physical condition with such a characteristic, is also a very difficult task. For these reasons the existence of a real Carnot machine is not known to date. Note that mechanically it is a very difficult to accomplish machine, but physical concepts states it is achievable, to the extent that it serves as a basis for valuation of all other technologies.

Some efforts of new solutions are found, whose purpose is to approximate the characteristics of the ideal Carnot machine, there are such characteristics in patents such as US20100313558 set by the author as the Modified Carnot cycle machine which uses as cold source a liquid gas reservoir, and patent US20110227347 set by the author as an intermediate machine cycle between the Stirling cycle machine and Carnot cycle machine. However the vast majority remains in the solutions based only on concepts of mechanical sciences, so the most modern projects still maintains solidarity the thermodynamic cycles of the mechanical cycle of the driving force elements movement, such feature unloosens solutions while maintaining acceptable virtually a single point of the power versus energy curve. Some others are also found with improvements in heat transfer, such as US20100287936 patent, based on the working gas handling rotors between the heat and cold areas, however the thermodynamic transformations exchanges borders are not well defined, because they depend on the mechanical solutions with the use of cams, gears, shafts, rods to assist in gas exchange in the respective zones, and others operate in chambers at essentially constant volumes, with one or more fully isolated chambers, considerably limiting performance. Thus, with such features, the vast majority existing solutions only operate with driving force pistons-type or quasiturbine-type elements.

In order to increase the yield, some projects based on machines that operate at high temperatures, allows you to combine two systems forming combined cycles, an example is the Brayton turbine, whose transformation process releases very hot gases to allow matching with a Rankine type turbine, allowing a combined Brayton-Rankine cycle system. However, these systems operate with fossil fuels, require high-tech materials to work with combustion chambers above 1000° C.

As noted above, most of the technologies rely on fossil-origin sources, highly harmful to the environment. Other low environmental impact technologies still are economically limited, or have technical limitations for large scale, or high powers or dependent on very special geological or atmospheric conditions, in this latter case may be exemplified wind and hydroelectric sources.

The technology developed, subject of this patent text is not an ideal lossless machine, however is a machine able to highly accurately perform the four transformations of the THERMODYNAMIC CARNOT CYCLE, from a heat source of any kind whose energy is transported to the machine by means of a thermal fluid, therefore, has the main characteristics desired, the same brings economic and practical application benefits and according to each project, power ranges and characteristics of heat sources may play very high yields, far surpassing the 40% of other high performance machines for sources of moderate temperatures and above 60% for high temperature sources.

The present invention has multidisciplinary sciences, the use of mechanical and electronics concepts, especially systems based on processors with logic programs that monitor and control high-speed actuators that recently did not exist for practical applications. It is worth as an example the hybrid technologies used in automobiles, which combine mechanical and electronic concepts with microprocessors, which significantly bring better performance and make machines flexible even with different fuels and different energy concentrations.

Another objective of singular importance is the use of this technology in plants of large power generation, flexible according to thermal sources, economically viable yield in the relation energy generated versus heat source and with minimal environmental impact, such as the use of clean thermal sources as solar, thermo-solar, low environmental impact as biofuels and economic as the use of waste and pre-existing plants, where it operates by heat losses, forming cogeneration systems, or added to other technologies forming more complexes processes called combined cycle such as forming combined Brayton-Carnot cycle systems, using as heat source the high temperature gases released by Brayton cycle turbines, Rankine-Carnot, whose heat source are steam outputs of the last stages of steam turbines and chimneys gases, Diesel-Carnot, whose heat source comes from the cooling fluid of the diesel machine, Otto-Carnot, whose heat source comes from the cooling fluid of the Otto cycle machine, among others, significantly broadening performance, since the processes of thermal machines of Brayton, Rankine, Diesel, Otto cycle, present many heat losses, which are impossible to be saved by its own thermodynamic cycles, necessitating more efficient alternative systems for this use.

The objectives, advantages and other important features of the subject invention may be better understood when read in conjunction with the attached figures, in which:

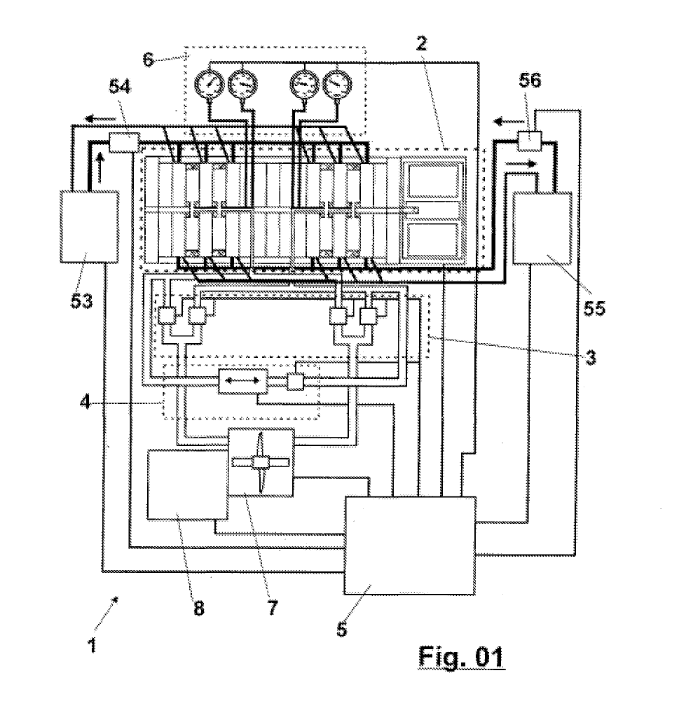

FIG. 01 represents a schematic view of the thermal machine.

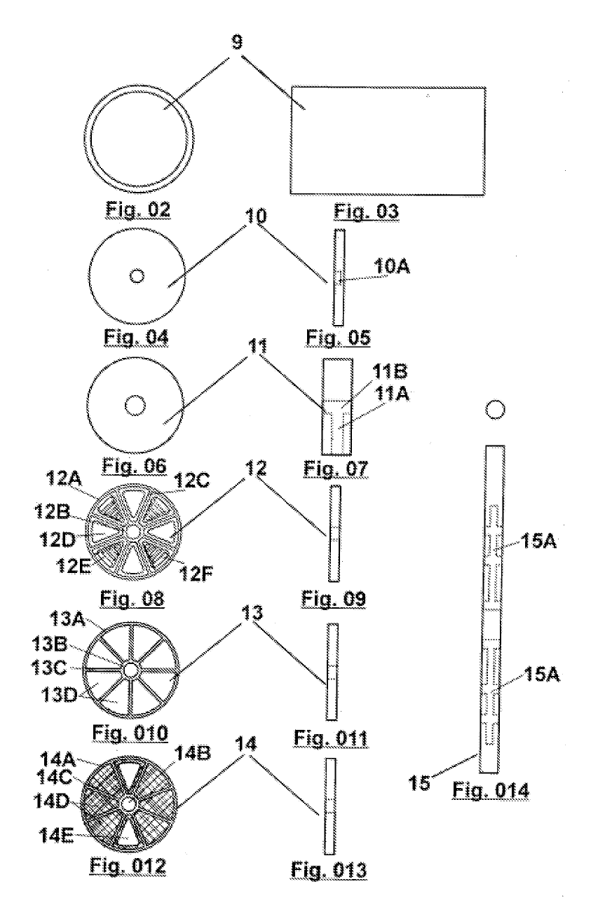

FIGS. 2 and 3 represent a front view and the other a side view of the inverter outer housing.

FIGS. 4 and 5 represent a front view and the other a side view of the housing cover.

FIGS. 6 and 7 represent a front view and the other a side view of the insulating disc with the gas flow channel.

FIGS. 8 and 9 represent a front view and the other a side view of the stator disc.

FIGS. 010 and 011 represent a front view and the other a side view of the stator extreme thermal insulating disc.

FIGS. 012 and 013 represent a front view and the other a side view of the rotor disc.

FIG. 014 represents a top and side view of the central rotor axis.

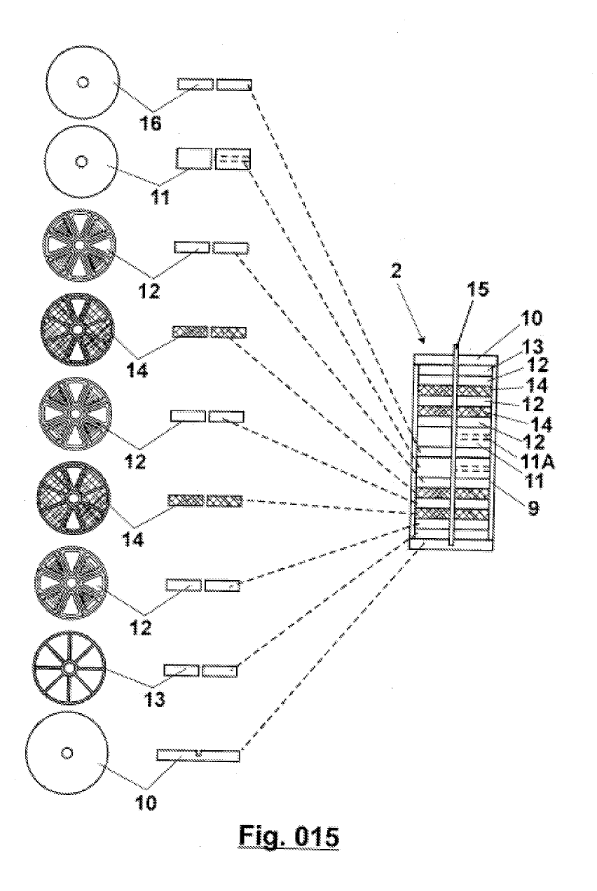

FIG. 015 represents the elements forming the stator and rotor sets of the inverter machine.

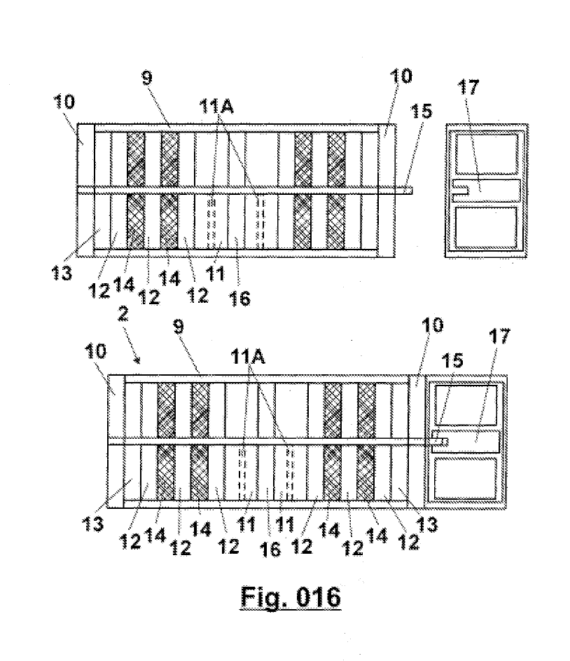

FIG. 016 represents a sectional side view of the inverter containing thermal machine's stator, rotor and servomotor.

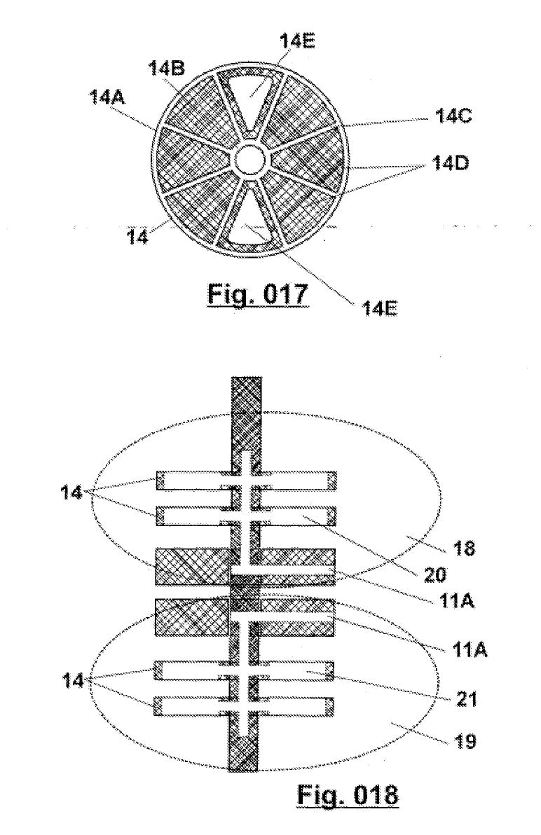

FIG. 017 represents a front view of the rotor disc.

FIG. 018 represents a sectional view of the inverter, showing the gas distribution channels within the thermodynamic processing chambers.

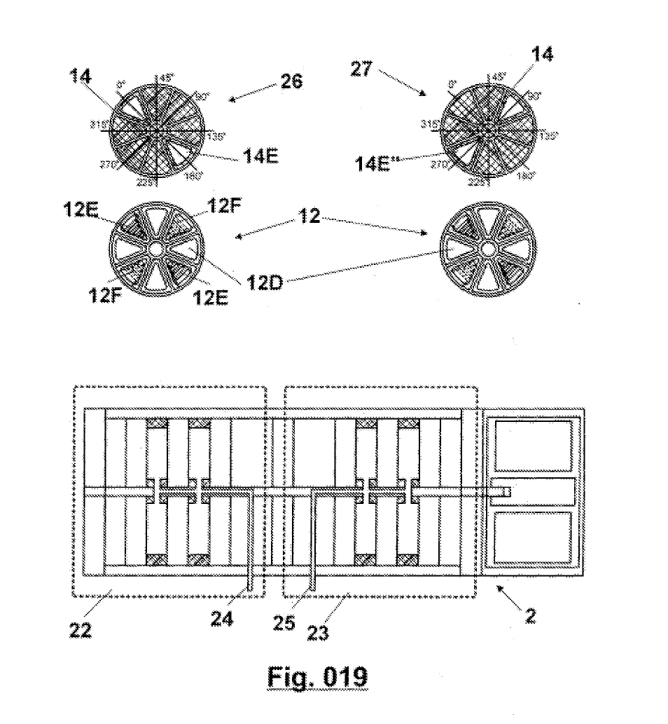

FIG. 019 represents a sectional side view of the inverter with the thermodynamic transformations chambers and their respective channels and the positioning of the stators and inverter chambers rotors.

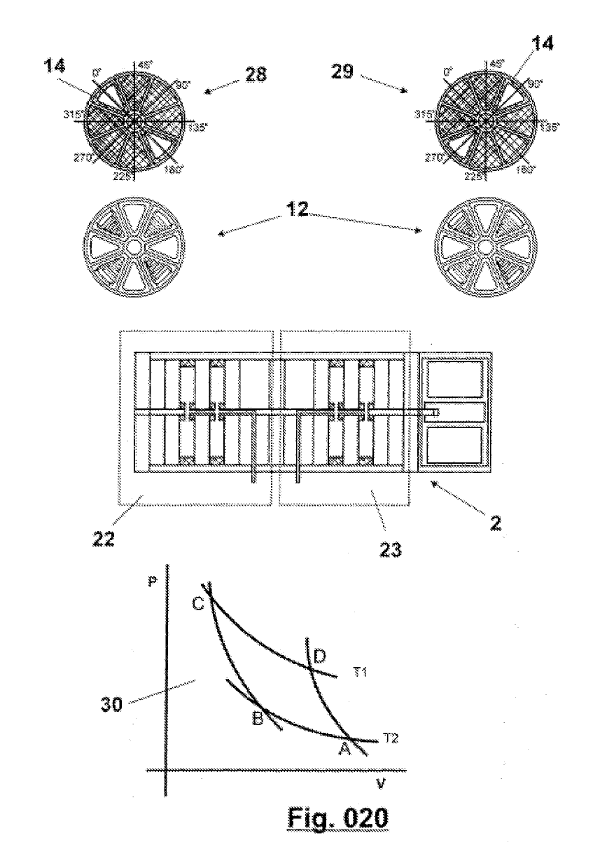

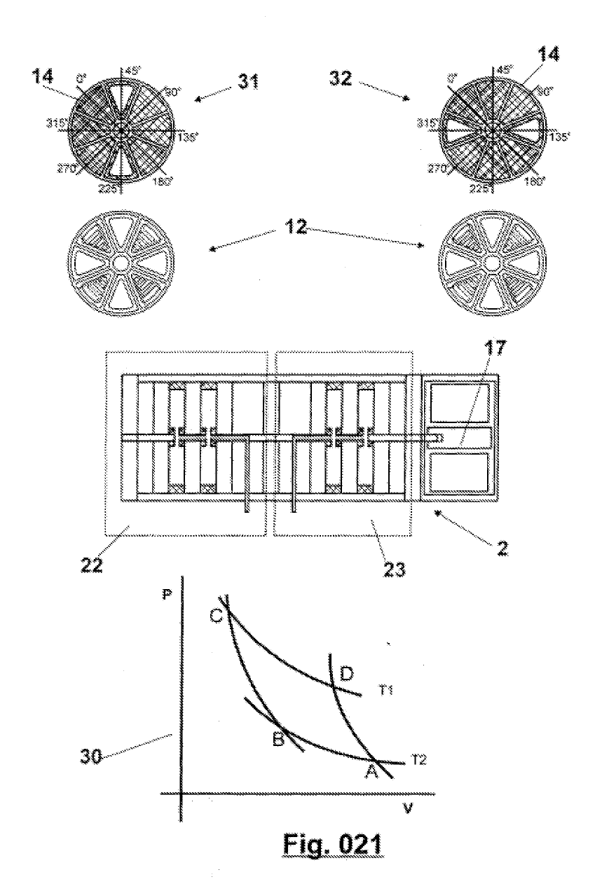

FIGS. 020, 021, 022 and 023 represent side sectional view of the inverter with the thermodynamic transformations chambers, the positioning of the stators discs and inverter chambers rotors and a graph representing the thermodynamic transformations, high and low temperature isothermals and adiabatic of expansion and contraction of the system gas.

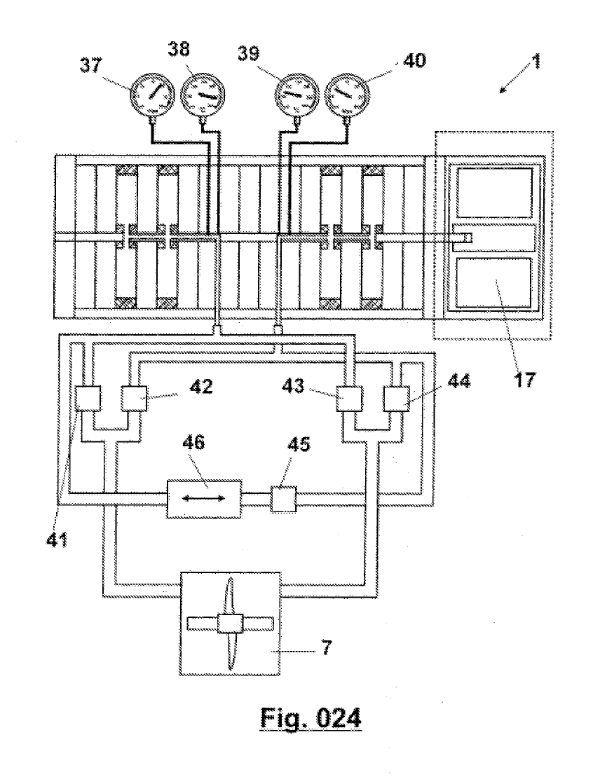

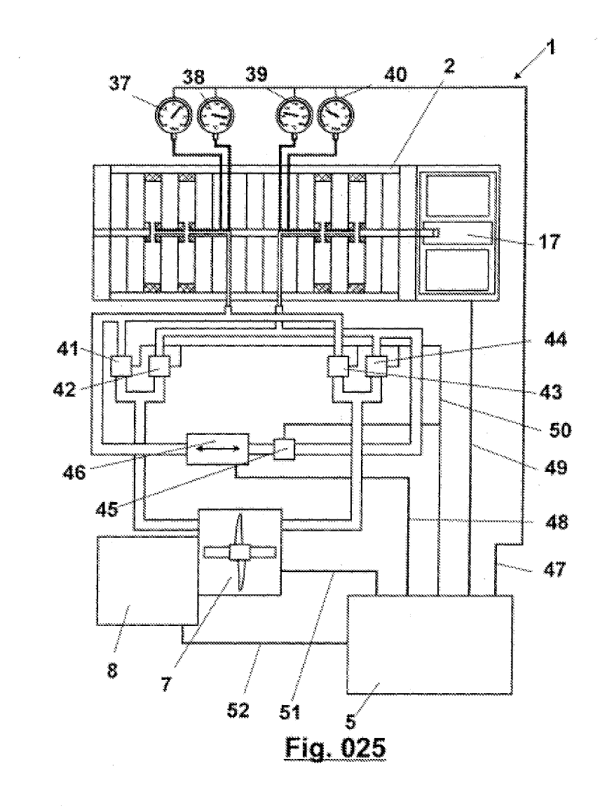

FIGS. 024 and 025 represent schematic views of the thermal machine where all the essential elements are evidenced.

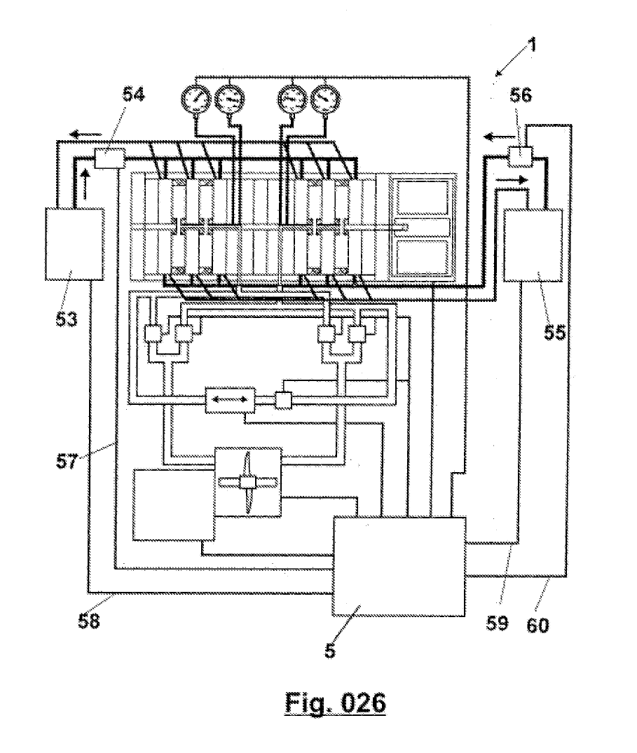

FIG. 026 represents a schematic view of the thermal machine in complete disposition.

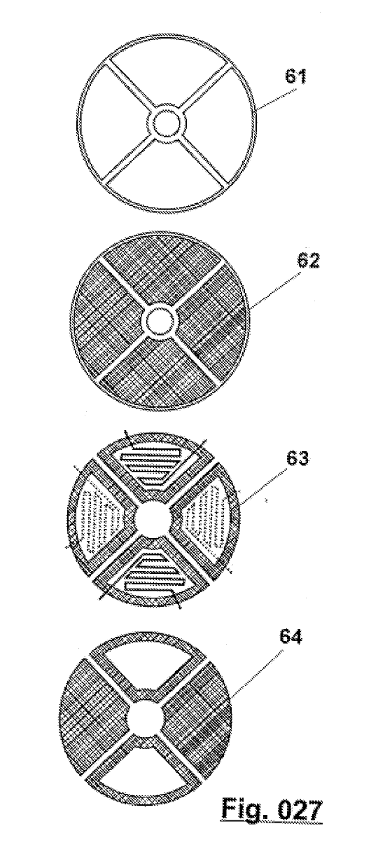

FIG. 027 represents a variant of the stator's heat transfer discs, rotor discs and thermal insulation discs.

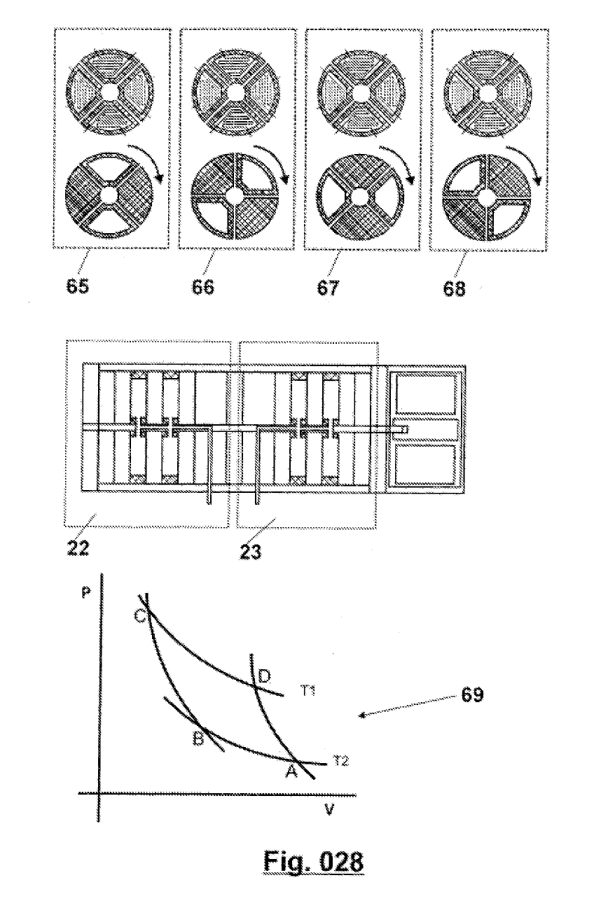

FIG. 028 represents side sectional views of the inverter considering the simplified variant of the stator and rotor discs, represented in FIG. 027, with the thermodynamic transformations chambers, the positioning of stator discs relative to the inverter chambers rotor discs to each one of the cycle thermodynamic transformations and a graph representing the four thermodynamic transformations of the system.

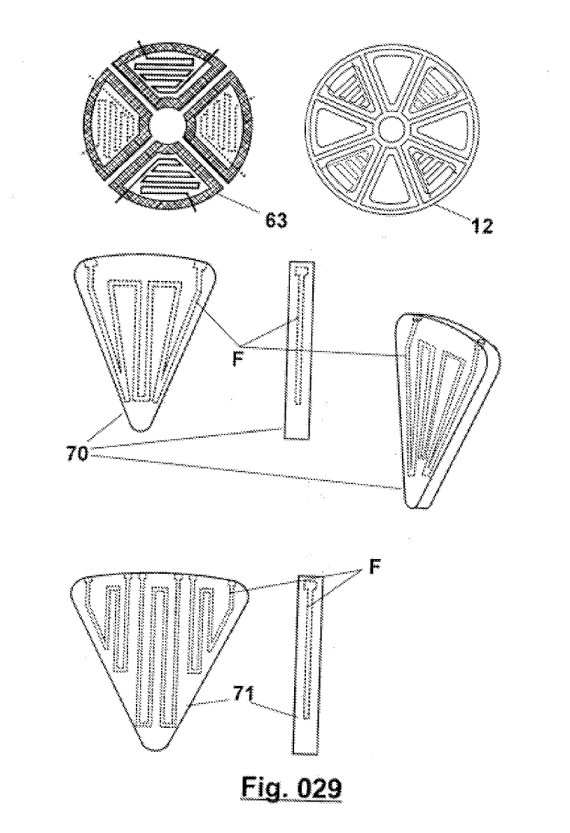

FIG. 029 represents the stator disc variants, showing the heat exchange plates and their fluid channels.

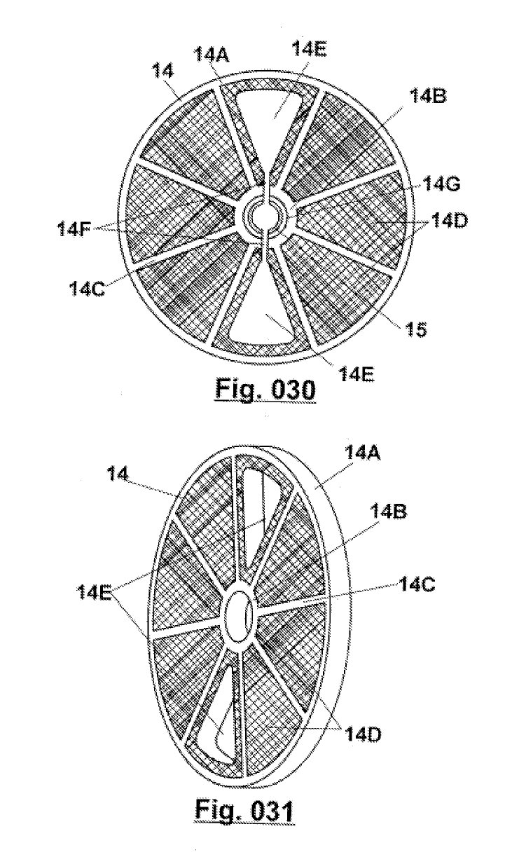

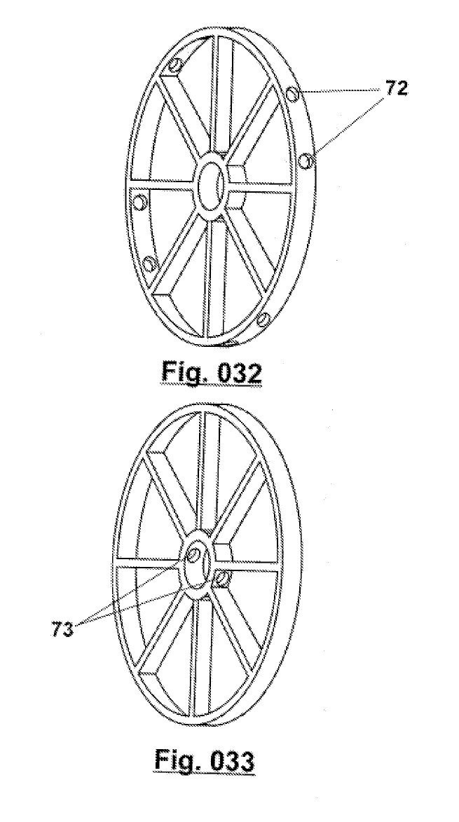

FIGS. 030 and 031 represent a front and perspective view of the rotor disc.

FIG. 032 represents a perspective view of the metallic structure that supports the stator heat exchanger plates, this same structure model is also used to support the thermal insulation plates of the inverter extremities.

FIG. 033 represents a perspective view of the metallic structure that holds the assembly consisting of thermal insulation plates and leaked plates during transport of the gas to the thermodynamic transformations of the working gas.

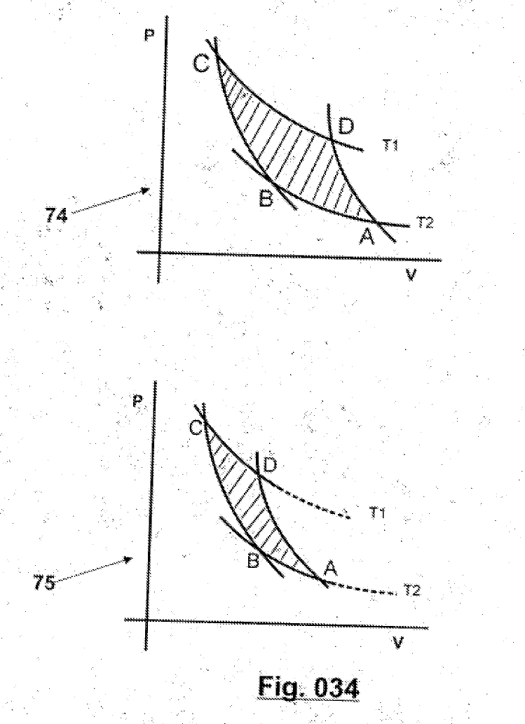

FIG. 034 represents the graphics with the thermodynamic transformations.

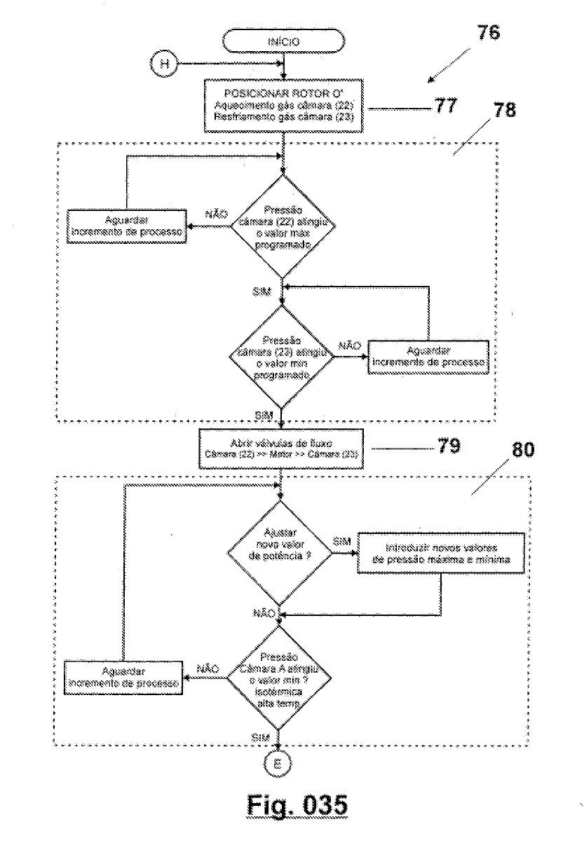

FIGS. 035, 036, 037 and 038 represent a flowchart of the thermodynamic cycle control process according to the Carnot cycle.

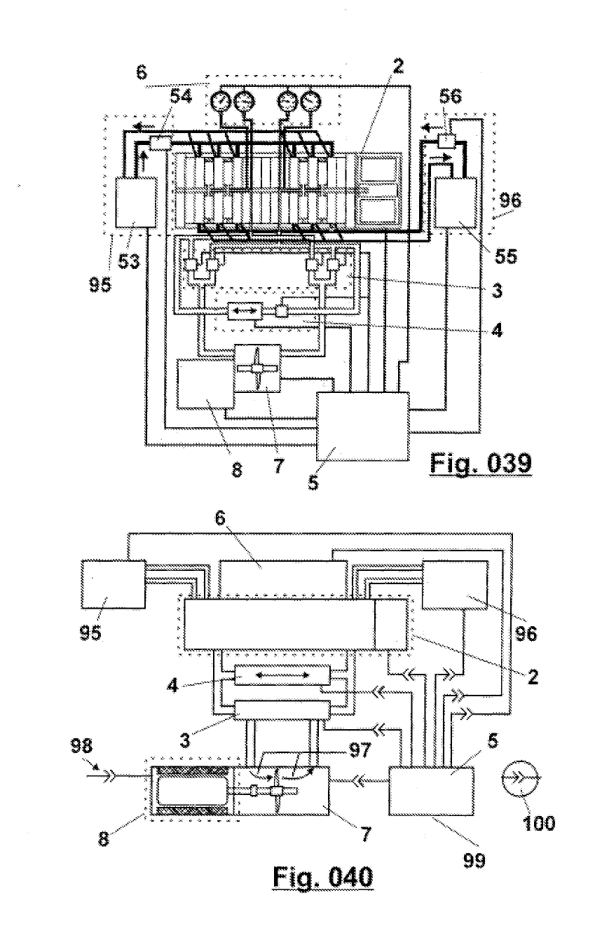

FIGS. 039 and 040 represent schematic views of the thermal machine in a more detailed version and another version in blocks showing the connections of power and control cables.

FIGS. 041, 042, 043 and 044 represent schematic views of the thermal machine, showing the applications with combined processes of different thermodynamic cycles.

As inferred in the attachments drawings, illustrating and integrating this descriptive report of the subject invention of “Thermal machine that operates in compliance with the THERMODYNAMIC CARNOT CYCLE and Control Process”, this is a machine that operates in accordance with the THERMODYNAMIC CARNOT CYCLE, being understood by a machine (1) in a closed circuit, comprising:
a thermodynamic transformation inverter (2), comprising a closed and thermally insulated cylindrical housing (9), where are disposed inside two thermodynamic chambers (22) and (23) parallel to each other, each chamber containing a plurality of heat exchange stator discs (12) and insulating stators discs (13) parallel to each other and fixed to the housing (9), and a plurality of intermediate rotor discs (14) fixed to a central shaft (15), provided with internal channels (15A) for the passage and distribution of fluid gas between the chambers, shaft being rotated by a servomotor or stepper motor (17) and angularly fixed by a rotating and angular positioning display accuracy element, called encoder added to the engine (17);
a pressure sensing element, or pressure transmitter (37) and (40) in each of the outlet ports of each chamber (22) and (23) that perform thermodynamic cycles;
a temperature sensing element (38) and (39) in each of the outlet ports of each chamber (22) and (23) that perform thermodynamic cycles;
a flow control module (3) consisting of piping and two two-valves flow sets (41), (42), (43) and (44) in two-way process control, which connects the work gas outputs of the thermodynamic chambers (22) and (23) to the outputs and inputs of the driving force element (7);
a compression module (4), provided with piping and valves (45), interconnecting the outlet of the chamber (22) forming part of the stator to a compression element (46), called compressor to the outlet of the second chamber (23) forming another part of the stator;
as independent driving force unit (7) that generates force to a power generator (8), by passing the heat fluid transfer of the thermodynamic cycle gas;
a logical control unit (5), with electronic actuator and a program containing the control process of all the elements that make up the thermodynamic cycle machine (1);
a unit that comprises a hot heat transfer fluid circuit with reservoir (53) and pump (54), connected to the thermodynamic chambers (22) and (23);
a unit comprising a cold thermal fluid circuit with a reservoir (55) and pump (56), connected to the thermodynamic chambers (22) and (23).

FIG. 01 represents the machine (1) with its main modules, the inverter (2); the valves system (3); the compression system (4); the microprocessed control unit (5) where the program that controls the process and especially the thermodynamic transformations is located; sensors module (6), with the pressure sensors (37) and (40) and temperature (38) and (39); the driving force element (7); the power generator (8); the hot fluid reservoir (53); the cold fluid reservoir (55); hot fluid pump (54); and the cold fluid pump (56).

In FIGS. 2 and 3 are shown two views of the cylindrical-shape housing (9), it should be made of pressure resistant material, usually stainless steel. The same can be whole, only one piece or split lengthwise.

In FIGS. 4 and 5, are shown two views of the housing cover (10) which may contain a central hole (10A) for housing or shaft passage (15), made of pressure-resistant material, preferably stainless steel.

In FIGS. 6 and 7 are shown two views of the insulating disc (11) of thermal insulating material, comprising a fluid passageway (11A), and a hollow central bore (11B), for fitting in the shaft, and driving the working gas of the thermodynamic processing chamber to the outside directed to the driving force element.

In FIGS. 8 and 9 are shown two views of the stator disc (12) which form the heat exchange units with the working gas which remains confined in the hollow spaces of the rotor disc (14). This disc (12) is formed by an outer ring (12A) and an inner ring (12B) made of hard material, usually steel, and between the rims, skates (12C) in strip shapes, resulting in a wheel shape. Among the skates are fixed four insulating plates (12D) of thermal insulating material, in the same thickness of the rims and skates, two heat transfer plates (12E) displaced from each other by 180 degrees, framed with thermal insulating material to isolate rims and skates, two heat absorbing plates (12F) displaced from each other by 180 degrees, also framed with thermal insulating material to isolate rims and skates. Each of the thermal fluid circulation circuits of the heat exchange plates have their respective exclusive supply from the reservoir or heat or cold source, this feature is important for machine performance and large machinery projects, is critical. The outer rim (12A) is fixed to the housing and inner rim (12B) is not fixed to the rotor shaft, since the shaft is freely movable.

In FIGS. 010 and 011 are shown two views of the thermal insulation stator disc (13) which are mounted at the ends of each chamber between the last thermal transference discs and the housing cover. This disc is also built with two rims, an outer rim (13A) and an inner rim (13B) of rigid material, skates (13C) connecting both rims resulting in the shape of wheel, among all skates are fixed thermal insulation plates (13D), filling the voids completely. The outer rim (13A) is fixed to the housing and the inner rim (13B) are not fixed to the shaft to keep this free for rotation.

In FIGS. 012 and 013 are show two views of the rotor disc (14), which are fixed on the shaft (15). These discs have the function of displacing the working gas between the regions that perform the 4 thermodynamic transformations. The disc is built with an outer rim (14A) and a center (14B) of rigid material, eight streaks (14C) of the same material and the same rim width, thermal insulating material plates (14D) are fixed on six out of the eight fractionated spaces, while keeping completely enclosed in two of the semi circles, symmetrically, are installed two pieces of thermal insulating material, however hollow (14E) so as to create a volume space where the machine working gas will be accommodated.

In FIG. 014 is showed the central axis (15) in which the rotor discs are fixed, this shaft is provided with two regions with hollow channels (15A), enabling the working gas to flow freely within their respective chamber, between the holes and heat exchange zones, this shaft is made of a rigid material and is internally coated with thermal insulating material.

In FIG. 015 are shown the two chambers with the stator and rotor assemblies forming the inverter (2), being evidenced: the central shaft (15); the outer housing (9); covers (10), thermal insulation stator discs (13); the heat exchange stator discs (12) with their hot, cold and isolated areas; the rotor discs (14) for displacement of the working gas; the insulating discs (11) with holes (11a) for conducting gas to the outside; and the partition cover (16) which separates the two chambers.

FIG. 016 represents a sectional side view of the inverter (2), which is the module comprised of two chambers of the machine which operates according to the Carnot cycle at complete disposition, where are show the outer housing (9); the covers (10); the central shaft (15); the servomotor (17) with added encoder, forming a single piece; the internal sets of stators and rotors, composed of the thermal insulation stator discs (13); the heat exchange stator discs (12) with their hot, cold and isolated areas; the rotor discs (14) for displacement of the working gas; the insulating discs (11) with fluid passageways (11a) for conducting gas to the outside; and the disc or partition cover (16).

FIG. 017 shows the rotor disc (14) in detail, this, coupled with the stator heat exchange disc are the main elements that enable carrying out the Carnot cycle. The rotor disc (14) is formed by a wheel made of a rigid material, typically steel, featuring an outer rim (14A) and a center rim (14B) interconnected by streaks (14C) mad of the same material, same width, a few millimeters width. The rotor has eight symmetrical areas, out of these, six are completely closed with thermal insulating material (14D) and two also with pieces of thermal insulating material, however hollow (14E) so as to create a volume where the working gas conducts the four thermal transformations during the thermodynamic process.

FIG. 018 shows the volume occupied by the gas in the thermodynamic processing chambers, (18) delimits the section of one of the chambers; (19) defines the other chamber, both operating on the Carnot cycle differentially. The rotor discs are indicated by (14). The volume available for the working gas is indicated in (20) and one of the chambers (21) in the other chamber. The holes and gas outlet channels of each chamber are indicated at (11A).

FIG. 019 is useful for understanding how this machine performs the Carnot cycle, where can be seen the inverter (2) of the machine with the detail of the chambers (22) and (23) of thermodynamic transformations and the representation of their respective channels (24) and (25). In the same figure should be considered that the stator discs (12) with heat exchange plates making the stators all aligned so that the heat transfer hot plates (12E) are all aligned and parallel to each other on the whole machine, as well as the heat absorption cold plates (12F) and insulating plates (12D). On the other hand, the rotor discs (14) at position (26) are aligned with their hollow areas (14E), all exposed to the hot regions in the chamber shown in (22), ie, the areas (14E) all aligned and parallel to the plates (12E). Conversely, in the chamber (23), rotor discs (14) at position (27), will be with their hollow areas (14E) aligned with the cold plates (12F). In this initial condition, it is understood that the gas contained in the chamber indicated by (22) is completely exposed to the heat and the gas contained in the chamber indicated by (23) is throughout exposed to cold.

From this initial condition is simple to understand how this machine works, below the full description.

The THERMODYNAMIC CARNOT CYCLE has four transformations, two isothermal and two adiabatic. This is the ideal machine cycle. In the Carnot machine project proposed, with less than 100% yield, obviously under thermal losses, the Carnot cycle is obtained as follows and can be understood by simplified flowchart (76) of the “looping” which controls the thermodynamic transformations shown in FIGS. 035, 036, 037 and 038 and also the power demanded by the machine shown in curves (74) and (75) of FIG. 034.

High temperature isothermal transformation, represented in FIG. 020, defined in the graph (30) by curve C-D, with the temperature T1. The working gas at the point C of the curve C-D of the graph (30) is under compression of the previous process in the chamber indicated by (22), the flow valves, represented in FIG. 024 by (41) and (44), all closed, the rotor disc (14) at position (28), completely exposing the gas in the hot zones of the stator discs (12), temperature T1 is quickly reached, favored by the geometry of the heating chamber which has large area exposed to the hot plates with a few millimeters depth of heat flow penetration, featuring an important differential against other existing geometries, the other boundaries of gas all thermally insulated. Upon reaching the temperature T1, the microprocessed control unit (5) of FIG. 025, open valves (41) and (44) allowing the gas to perform work until it is detected by the processing unit (5) the pressure at point D in Curve C-D of the graph (30), at which point the control unit closes the valves (41) and (44). Throughout the isothermal transformation stage, the heat flow from hot sources for gas is kept, if that did not occur, the temperature would drop and the pressure would fall more than desired, impairing machine performance. In processes that high accuracy for isothermal transformation is desired, a feedback can be used so as to modulate the thermal fluid flow, by increasing the flow rate at the pump (54) represented in FIG. 026 during stage C-D of the cycle. The thermal fluid carries heat from the reservoir (53) to the hot plates, the working gas removes it, the thermal fluid returns to the heating system with a lower temperature than entered into the machine, thus modulating the flow during the isothermal stage, obtaining a growing positive differential temperature of the plates, offsetting a possible drop, improving this isothermal transformation. During this transformation, gas moves from the chamber (22) performing work on the driving force element, typically a turbine or engine (7) and follows to the chamber (23).

This isothermal transformation process may be better understood by Fourier's law of conduction:

q″=−k·∂T/∂x (W/m²) or q″=−k·(Ta−Tb)/L (W/m²)

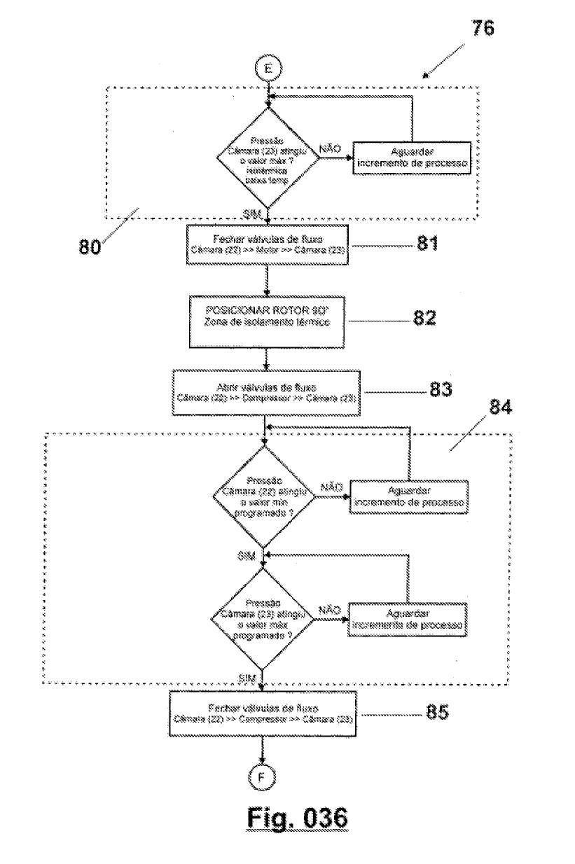

This isothermal transformation is also shown in the flowchart (76), in FIGS. 035 and 036 is shown by steps (77), (78), (79), (80) and (81).

Therefore, to maintain the isothermal transformation, where process T1 is equal to “Ta” of the formula above, it is sufficient to keep the flow q″ constant during this step, which is facilitated by the geometry explained just above, if the system requires more energy simply modulate the thermal fluid flow to adding the value the temperature “Tb” in the heat plates. The control module (5) of the process is able to perform this control.

Adiabatic expansion processing shown in FIG. 021, set in the graph (30) by curve D-A. At this point in the cycle, servomotor (17) executes an angular movement of the rotor disc (14) at position (31), at high speed, positioning the working gas volume to the hot zone region for the thermally insulated area for all the sides. Thus, the gas does not lose nor receives energy from the environment. The control unit opens the valve (45) and activates the compressor (46) shown in FIG. 024, taking advantage of the chamber pressure residual differential (22) or part of the energy of the driving force element (7) to compress the working gas, moving the camera (22) to the chamber (23). In this stage, with the adiabatic expansion, the gas temperature changes from T1 to T2 and the control unit (5) closes the valve (45) and disable the compressor (46).

This adiabatic transformation is also shown in the flowchart (76), in the FIG. 036 is shown by steps (82), (83), (84) and (85).

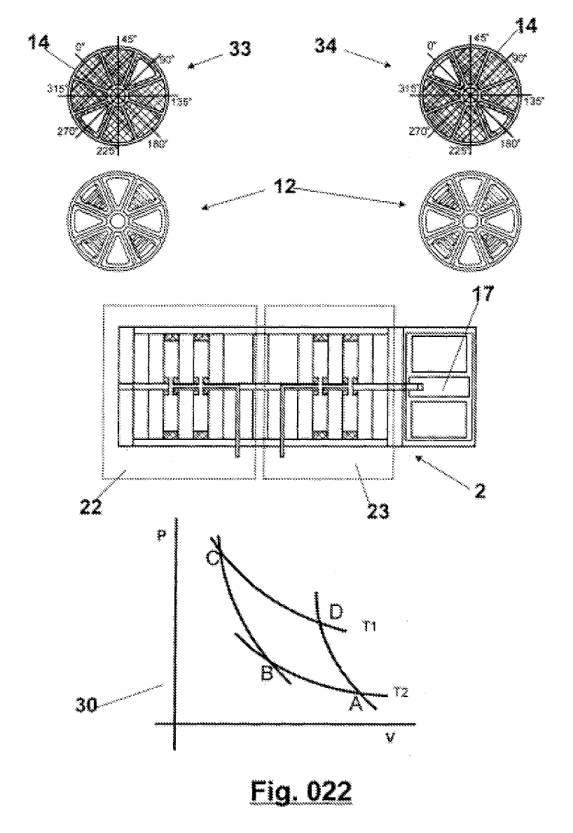

Low-temperature isothermal transformation, shown in FIG. 022 defined in graph (30) along the curve A-B, with temperature T2. The working gas at the point A of the curve A-B of the graph (30) is at maximum expansion of the previous process in the chamber indicated by (22), the flow valves, (42) and (43), all closed, the rotor disc (14) at position (33), exposing the gas completely in the stator cold zones (12), the temperature T2 is quickly reached, favored by the geometry of the cooling chamber which has a large area exposed to the cold plates with depth of penetration of the heat flux, now from gas to the plates, of a few millimeters, the other boundaries of gas all thermally insulated. Upon reaching the temperature T2, the microprocessed control unit (5) of FIG. 025, open valves (42) and (43) allowing gas now receiving work until it is detected by the processing unit (5) at pressure of the point B of curve A-B of the graph (30), at this point the control unit (5) closes the valves (42) and (43). Throughout the isothermal transformation stage, the gas heat flow is retained to the cold sources, because if this does not occur, the temperature would rise and the pressure would rise more than desired, impairing machine performance. In processes that high accuracy is desired from isothermal transformation, can be used a feedback so as to modulate the thermal fluid flow by increasing the flow rate at the pump (56) represented in FIG. 026 during stage A-B of the cycle, removing more heat from gas. The thermal fluid carries heat from plates by, removing from gas, and transports it to the reservoir (55), the thermal fluid returns to the cooling system with a temperature higher than it entered in the machine, thus modulating the flow during the isothermal stage, obtaining a decreasing negative differential of the temperature of the plates, making up a possible increase, improving this isothermal transformation. During this transformation gas moves from chamber (23) performing work on the driving force element (7) and continues to the chamber (22), conversely to the first high-temperature isothermal processing.

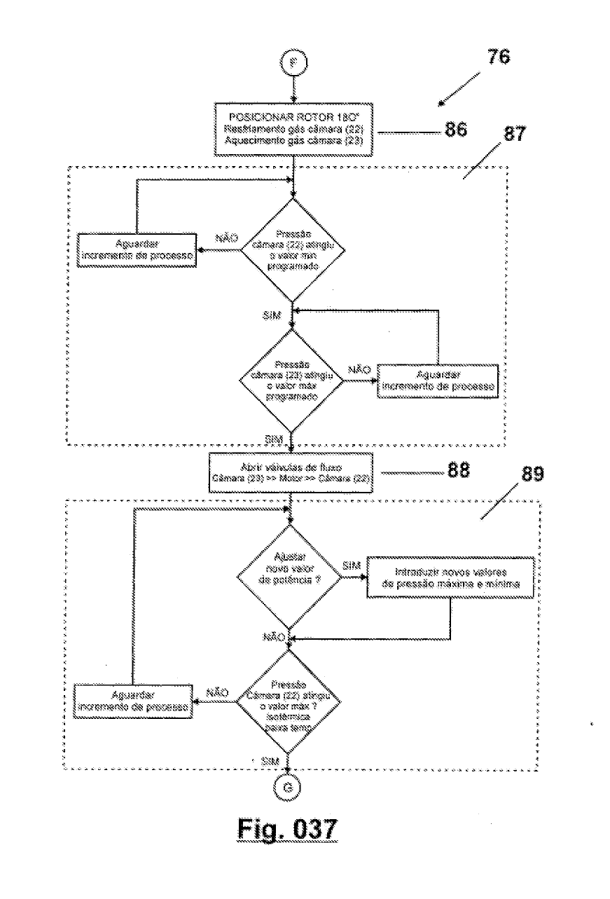

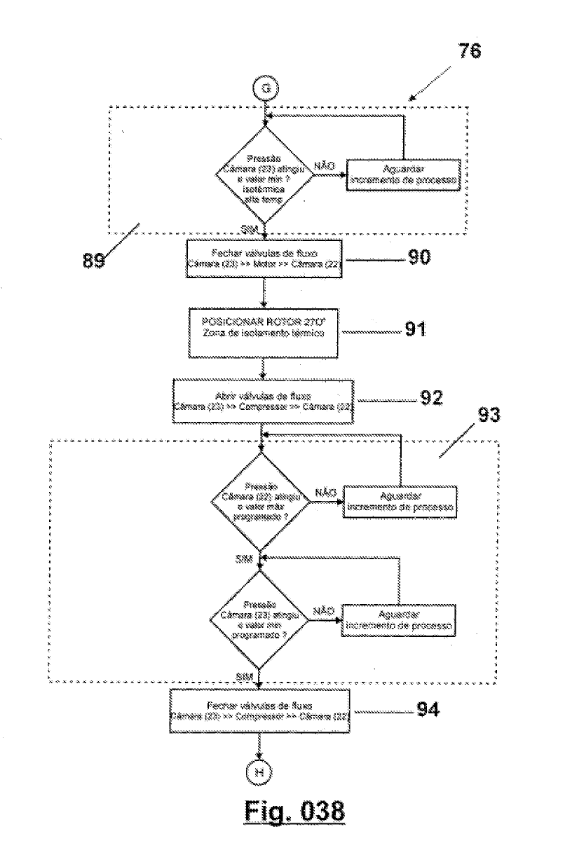

This isothermal transformation is also shown in the flowchart (76) in FIGS. 037 and 038 is shown by steps (86), (87), (88), (89) and (90).

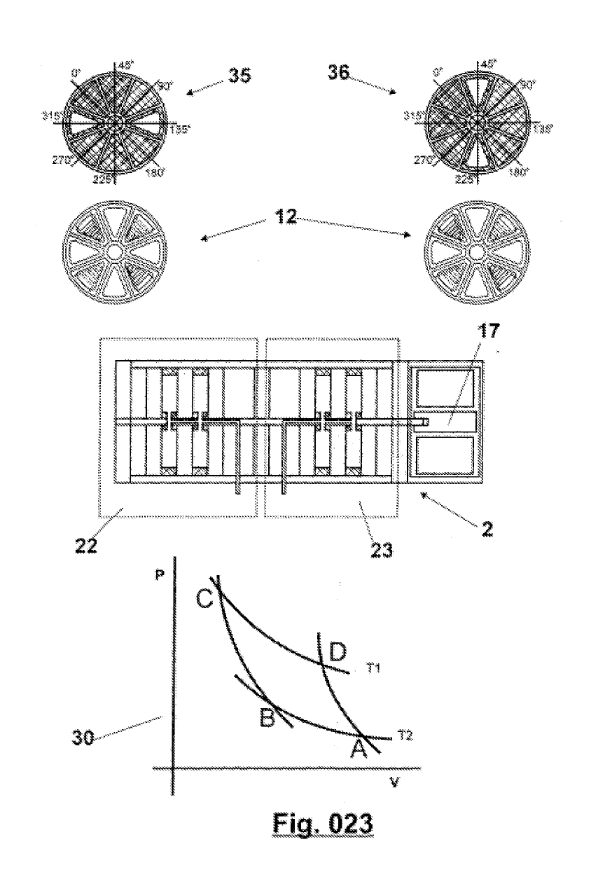

Adiabatic compression processing shown in FIG. 023, set in the graph (30) by Curve B-C. At this point in the cycle, servomotor (17) executes an angular movement of the rotor (14) at position (35) at high speed, positioning the working gas volume of the cold zone of preview transformation process, to the thermally isolated region by all faces. Thus, gas does not lose nor receives energy from environment. The control unit opens the valve (45) and activates the compressor (46) shown in FIG. 024, taking advantage of the residual differential of the chamber pressure (23) or part of the energy of the driving force element (7) to compress the working gas, moving from chamber (23) to the chamber (22). In this stage, with adiabatic compression, the gas temperature changes from T2 to T1, and the control unit (5) closes the valve (45) and disables the compressor (46).

This adiabatic transformation is also shown in the flowchart (76), in FIG. 038 is shown by steps (91), (92), (93) and (94).

Important noticing that in this invention, the THERMODYNAMIC CARNOT CYCLE occurs differentially, whereas a change occurs in the chamber (22), also occurs similarly and reversed in the chamber (23).

In FIGS. 024 and 025 is represented the machine with all the essential elements, pressure sensors or transmitters (37) and (40), temperature sensors (38) and (39), drain valves (41), (42), (43) and (44) the expansion and compression valve (45) to the compressor (46) with an internal arrow indicating that it operates with the flow in two directions, the driving force element, usually turbine or motor (7), the microprocessed control unit (5), the control lines of sensors and actuators, (47), (48), (49), (50), (51) and (52) the electricity generator (8), the inverter (2) and the servomotor (17).

FIG. 026 shows the hot thermal fluid reservoir (53), with their respective booster pump (54), the reservoir of cold thermal fluid (55) and its booster pump (56), the control lines of the pumps by microprocessed unit (57) and (60), and the reservoirs control lines (58) and (59). The hot thermal fluid is heated by a heat source of any kind, for example, solar, geothermal, by atomic origin, renewable (or not) fuels, among others, and subsequently transported to the reservoir (53) with thermal insulation, the cold thermal fluid is cooled by a cold source, for example, tap water, convection air in the soil itself as a heat sink, among other and then transported to the reservoir (55) with thermal insulation.

For machines that operate at the adiabatic processing in transition, i.e., which do not have the unique thermal insulation plates, the stator and rotor discs have a configuration with four semicircles and not eight. The set of components that make up this new configuration is represented in FIG. 027, at (61) the wheel of a rigid material, typically steel, with two rims connected by four streaks of the same material and same width. In (62) the isolating disc of the last heat exchange plates with the housing is formed by a wheel as indicated by (61) filled the four semi circles by thermal insulating material plates. In (63) the stator disc with the heat exchange plates, with two pieces hot plates isolated from wheel by means of other piece of thermal insulating material and with two other parts for the cold plates isolated from wheel via another piece of thermal insulating material. In (64) the rotor disc formed by the wheel (61) with two semi circles completely filled by a thermal insulating material and two with thermal insulating material, however hollow to accommodate the working gas.

The THERMODYNAMIC CARNOT CYCLE performed by a machine with the rotor and stator configuration as shown in FIG. 028, operates its adiabatic transformations that in some cases this transformations, in the transition, may have isochoric characteristics and approach the characteristics of a Stirling machine. In (65) is indicated the working gas exposed to heat, conducting high temperature isothermal stage according to the curve C-D of the graph (69). In (66) the gas is in the transition between the hot and cold regions, at this stage the gas is expanding by absorbing heat, but it moves to the cold region and performs processing D-A of graph (69). In (67) is indicated the working gas exposed to cold by performing the low temperature isothermal phase according to curve A-B of graph (69). In (68) the gas is in the other transition between the hot and cold regions, at this stage the gas is under compression releasing heat, however it travels into the hot region and performs processing B-C of the graph (69).

In FIG. 029 are represented again the heat exchange stator discs, (12) and (63), in the configurations with the isolated area and without it, in each case, follow the constructive models of each heat exchange plate through which circulates the thermal fluid (70) for small size machines, with a single thermal fluid channel (F) per plate, and (71) for larger machines with multiple channels of thermal fluid (F) per plate. However, according to power the number of circulation circuits of the thermal fluid (F) can be increased, as well as the number of segments. The circulation channels of the thermal fluid (F) are machined directly into the heat exchange plate, usually metallic aluminum, stainless steel or other alloy to obtain good heat transfer and are machined in two mirrored version plates and then externally remachined. These plates can be fragmented into several segments according to the required project size.

In FIGS. 030 and 031 are shown in greater details the rotor discs (14) formed by an external rim (14A); an inner rim (14B); eight spokes (14C); six of the eight fractionated spaces are fixed plates made of thermal insulating material (14D) keeping completely closed; two fractionated spaces equipped with two thermal insulating material pieces, however hollow (14E) so as to create a volume space where the working gas of the thermodynamic transformations areas; a channel (14F) for the gas flow; and the inner thermal insulation (14G) of the rotor shaft (15).

In FIG. 032 is shown in details the metallic structure that supports the stator heat exchanger plates, indicating in (72) the openings through which the connections that allow connecting the tubes of the thermal fluid to the heat exchange plates. In a similar structure, not requiring holes for the connections, are mounted the thermal insulators which make the isolation of the last stator discs with the covers of the extremities.

In FIG. 033 is shown in details the metallic structure that holds the assembly of thermal insulation plates and hollow plates for transporting the gas during the thermodynamic transformations of the working gas. The holes 73 give way to the working gas between the hollow area and the hollow segment of the shaft, while maintaining open communication between all hollow areas of the respective chamber.

In FIG. 034 are shown the graph with the thermodynamic transformations again, portraying the “Pressure versus Volume” relation. In (74) the base graphic of the description of this project, in (75), the example of an innovative feature that the aggregated electronic system, along with the disengagement of the thermodynamic cycle from mechanical cycle provides. This is a very significant evolution that the systems based on the Stirling cycle, the system closer to the Carnot machine until then, do not have, such evolution makes technology more flexible and active in a wide range in the power curve. The control of transformations, modulating in time the relation of isothermal and adiabatic transformations, allows energy conservation when the system operates with lower demand, hatched lines indicate the work that the machine performs in each case. The process of how power becomes controllable is better understood by observing the flowchart (76), especially steps (80) and (89).

FIGS. 035, 036, 037 and 038 show a process flowchart which controls the thermodynamic Carnot cycle with two isothermal transformations and two adiabatic transformations through the flowchart (76), where are included steps of:
angularly position the rotor at 0° by exposing the Chamber Gas (22) in the heating zone and the chamber gas (23) in the cooling zone (77);
wait for the chamber gas (22) reaches the maximum set pressure value and the chamber gas (23) reaches a minimum pressure value (78);
Open flow valves that lead the chamber gas (22) to the chamber (23) through the driving force element (79);
Check if there is new pressure parameter, if positive, introduce, if negative, maintain, wait for the chamber pressure (22) reaches the programmed minimum value and wait for the Camera (23) reaches the programmed maximum pressure (80);
Close the flow valves leading the Chamber gas (22) to the Chamber (23) via the driving force element (81);
Angularly position the rotor at 90°, exposing the Chamber Gas (22) in the thermally isolated area and the Chamber Gas (23) also in the thermally isolated area (82);
Open the flow valve that leads the Chamber Gas (22) to the Chamber (23), passing through the compressor (83);
Wait the chamber (22) reaches the programmed minimum pressure and wait the chamber (23) reaches the programmed maximum pressure (84);
Close the flow valve that leads the chamber Gas (22) to the chamber (23), passing through the compressor (85);
Angularly position the rotor at 180° by exposing the chamber Gas (22) in the cooling zone and the chamber gas (23) in the heating zone (86);
Wait for the chamber gas (22) reaches the pressure in the programmed minimum value and the chamber gas (23) reaches the maximum pressure value (87);
Open flow valves that lead the chamber gas (23) to the chamber (22), via the driving force element (88);
Check if there is new pressure parameter, if positive, introduce, if negative, maintain, wait for the chamber pressure (22) reaches the programmed maximum value and wait for the Camera (23) reaches the programmed minimum pressure (89);
Close the flow valves leading the chamber gas (23) to the chamber (22) via the driving force element (90);
Angularly position the rotor at 270°, exposing the chamber gas (22) in the thermally isolated area and the chamber Gas (23) also in the thermally isolated area (91);
Open the flow valve which leads the chamber gas (23) to the chamber (22) via the compressor (92);
Wait the chamber (22) reaches the programmed maximum pressure and wait the chamber (23) reaches the programmed minimum pressure (93);
Close the flow valve, which leads the chamber gas (23) to the chamber (22) via the compressor (94);

Once the cycle described above is finished, the process continuously repeats, making the machine operate according to the Carnot cycle.

The best result does not necessarily occur with the performance, it needs each one of the transformations of the Carnot cycle phases, isothermal and adiabatic, but with the best ratio between energy obtained in the system output and the amount of thermal energy supplied to it. Thus, the present invention proposes an intelligent control and processing unit with points of control for the process and points of measurement of the different magnitudes.

The symmetrical circular model of the rotor and the stator plates, as well as the availability of heat exchange plates, allows high flexibility together with the microprocessed control unit, allowing the machine to be adjusted by programming routines, to the best possible performance point, enabling large machine processes with greater inertia, no stops and processes with machines with low inertia rotor with slight movement and angularly accurate.

In FIGS. 039 and 040, allows us to understand another very important feature, especially for aerospace applications, in FIG. 039 the machine with key elements, so that (95) represents the hot fluid reservoir assembly (53) and its respective pump (54), (96) represents the cold fluid reservoir assembly (55) and its respective pump (56), just below in FIG. 040, the machine with all the elements in blocks (99) preserving its reference numbering of the main elements, so that attempts to characterize that there is no moving mechanical element, whether is plungers, pistons, shafts, absolutely no mechanical element that makes the border between the working gas and the external environment which may generate leaks. This is a property of the proposed system with its thermodynamic transformations according to the differential Carnot cycle, in 97 is shown the working gas flow through the driving force element, the electricity generator (8), solidarity fixed to the driving force element (7), the entire assembly completely screened. The connections for control of the sensing elements, actuator elements and for power outputs are through electrical connections or shielded outlets (100). Indicated by (98) the output jack of the electricity generated.

All non-ideal thermal machines convert only a fraction of energy into mechanical power, part of the energy received from the primary source, fuel or other heat source is released as heat to the environment in a greater or lesser amount depending on their thermodynamic transformations cycle, for example: a Brayton cycle gas turbine has an internal combustion which generates gas at temperatures exceeding 1000° C., convert part of the energy into mechanical force on the turbines and releases very hot gases to the environment, these in the order of 500° C. to 600° C. or more. A Rankine cycle steam turbine generally operates with temperatures between 400° C. and 800° C., lose energy in raising the water temperature, in the phase transformation, in chimneys and the return of steam to condensation after the last stage of the turbine, Diesel cycle engines and Otto cycle, internal combustion, similarly to the Brayton cycle also release gases at high temperatures that lose to the environment through the housing of the machine itself that must be maintained at safe temperatures of the cooling fluids. Among other thermal machines, all these can be added to the inverter, subject of this patent, to create combined cycles and thus optimize the overall performance of the conversion of energy from the primary source. This is possible because of this inverter operate including with low temperature differentials.

In FIGS. 041, 042, 043 and 044, are shown applications with combined processes of different thermodynamic cycles, energy systems or force formed by Brayton type gas turbines release in the atmosphere very hot gases after combustion, large masses of gases at temperatures between 500° C. and 600° C. approximately, representing large amounts of wasted energy. The Carnot cycle thermomechanical inverter can take advantage of this energy disposed from turbine to perform a Carnot cycle conversion by adding power to the same main turbine shaft by raising the yield of the assembly to values greater than 60%, so the system becomes a set of Brayton-Carnot combined cycle as shown in (101) and in FIG. 041.

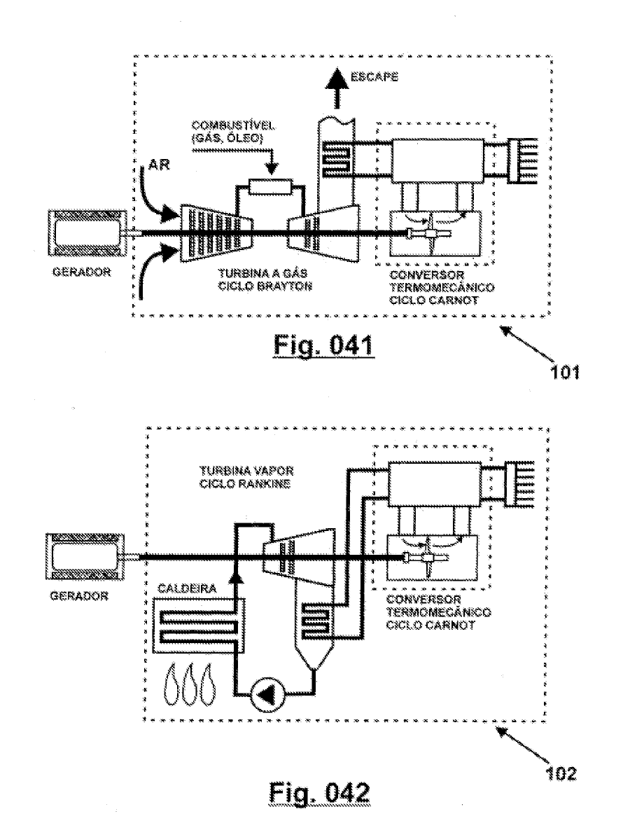

In FIG. 042, at (102) is shown the basic diagram of a Rankine-Carnot combined cycle, in this process, after the last stage of turbines, steams with temperatures between 100° C. and 200° C. lose energy to the environment and in the condensation process, this energy is transferred to the inverter subject of this patent to perform a new thermomechanical conversion adding power to the same force axis, thus maximizing the efficiency of the assembly, making it a combined Rankine-Carnot cycle (102).

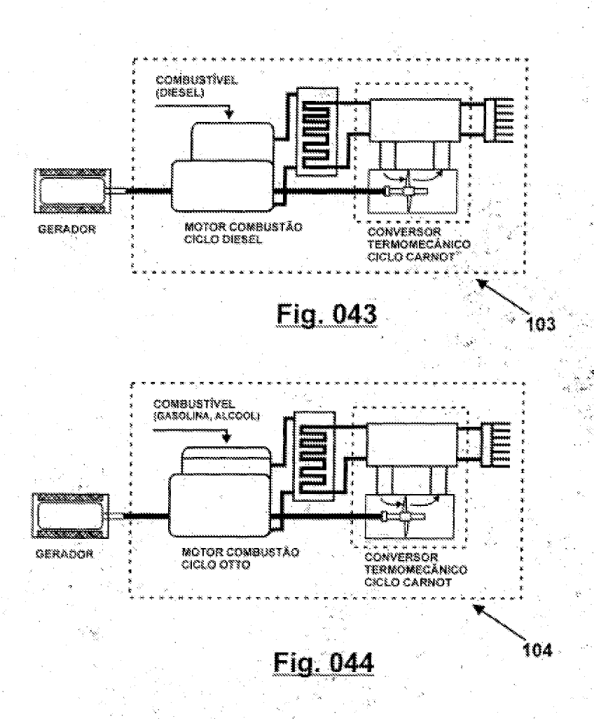

In FIG. 043, in (103) is shown the basic diagram of a combined Diesel-Carnot cycle, in this case, the Diesel cycle engine releases after the burst phase on the piston within the cylinder, still very hot gases whose heat spreads to the motor housing and the exhaust, this energy as heat can be transferred by means of the machine cooling fluid to the circuit forming the thermomechanical inverter, allowing the execution of one more thermodynamic transformation with a force transfer to the same axis, creating a new more efficient system, called Diesel-Carnot combined cycle (103).

In FIG. 044, in (104) is shown the basic diagram of a Otto-Carnot combined cycle, in this process, the Otto cycle engine releases after the burst stage on the piston within the cylinder, still very hot gases whose heat spreads to the engine housing and the exhaust, this energy as heat can be transferred by means of the machine cooling fluids for the circuit forming the thermomechanical inverter, allowing the execution of one more thermodynamic transformation with force transfer to the same shaft, creating a new more efficient system, called Otto-Carnot combined cycle (104).

The combined features of the present invention which in summary are: geometry of the heat transfer elements for the gas, insulation and concentration model of the heat inside the chambers, thermodynamic transformations process according to the differential Carnot cycle, with the working gas flow passing from a chamber to another, and a microprocessed electronic control system, along with the sensor elements of the process, temperature, pressure and angular position, provides this machine superior performance, allowing large machines projects in electricity generation to supply major consuming regions, for commercial use on a large scale, with the use of multiple thermal sources, especially thermo-solar, allowing including operative systems with low temperature differentials between hot and cold sources from about 50 Kelvin. By innovation characteristics proposed with the use of electronic control unit and servo drives, allows its use in replacement to engines for use in vehicles.

Its operation characteristic of independent thermodynamic cycles of the mechanical cycle of the driving force allows projects, which have as driving force principle to gas pressure and also gas flow, favoring projects both with pistons and turbines or other driving force element.

As described above, this invention provides substantial innovation for future energy systems, now based on thermodynamic theory of Sadi Carnot, considered the ideal model for transforming thermal energy into work. Has as objectives to its application in power generation plants with the basic source, thermo-solar energy and as complements, geological origin thermal sources, biofuels and also in special cases or to complement the fossil-origin fuels and even nuclear.

We conclude that this is a technology that meets an unusual flexibility, and therefore will bring benefits in accordance with the standards that one at the present time.

1. “THERMAL MACHINE OPERATING PURSUANT TO THERMODYNAMIC CARNOT CYCLE” it is an invention that uses the basic principles of thermodynamic Carnot cycle, and the thermal machine characterized by comprising a closed circuit, comprising:
a power inverter that performs thermodynamic transformations, consisting of a thermally closed and isolated cylindrical housing, where inside are arranged two concentric thermodynamic cameras, but with differential thermodynamic transformations operations promoted by 180° offset, each chamber containing a plurality of heat exchange stators discs and insulating stators discs parallel to each other and fixed to housing, and a plurality of hollow intermediate discs forming the rotor, fixed to a central shaft, provided with internal channels for the passage and distribution of gas fluid between hollow areas of stator discs in each chamber, being rotational axis by a servomotor or stepper motor, and angularly controlled by a rotation indication sensor element and angular accuracy positioning called encoder added to the servomotor or stepper motor;
a pressure sensor element or pressure transmitter in each of the outlet orifices of each chamber which carries out thermodynamic cycles;
a temperature sensor element in each one of the outlet orifices of each chamber which carries out thermodynamic cycles;
a flow control module equipped with piping and two sets of process control two-way flow valves that interconnect the working gas outputs of the thermodynamic transformations chambers to the outputs and inputs of the driving force element;
a compression module, formed by ducts, compressor, valves, which connect the output of one of the chambers to the exit of the second chamber
an independent driving force unit that generates force to a power generator or to provide mechanical tensile strength, which operates through the passage of the thermal fluid of the thermodynamic cycle gas;
a logical control unit, with electronic actuators and a program containing the control process of all elements making up the thermal machine;
a unit that comprises a hot thermal fluid circuit with reservoir and pump, interconnected to the thermodynamic chambers;
a unit that comprises a cold thermal fluid circuit with reservoir and pump, interconnected to the thermodynamic chambers.

2. “THERMAL MACHINE OPERATING PURSUANT TO THERMODYNAMIC CARNOT CYCLE” according to the claim 1 is characterized by rotor discs having rigid material streaks and inner rims fixing to the shaft and outer rims interconnected by the streaks divided into eight symmetrical semi circles with six of them completely filled with thermal insulating material and two of them with thermal insulating material, but hollow in order to create a volume to be filled with the working gas, leaving exposed two major areas to completely border with the heat transfer or isolation zones, each required to perform the respective transformations of the thermodynamic cycle.

3. “THERMAL MACHINE OPERATING PURSUANT TO THERMODYNAMIC CARNOT CYCLE” according to claim 2 is characterized by a rotor disc variant having rigid material streaks and internal rims fixing to the shaft and external rims connected by streaks divided into four symmetrical semi-circles, with two of them completely filled with thermal insulating material and two of them with thermal insulating material, but hollow in order to create a volume to be taken by the working gas, leaving exposed the two biggest areas to borders completely with heat transfer areas for machines with direct transition between isotherms, hot and cold heat transfer regions.

4. “THERMAL MACHINE OPERATING PURSUANT TO THERMODYNAMIC CARNOT CYCLE” according to claim 1 is characterized by the internal channels of the central axis to be internally coated with thermal insulating material.

5. “THERMAL MACHINE OPERATING PURSUANT TO THERMODYNAMIC CARNOT CYCLE” according to claim 1 is characterized by having a servo motor or stepper motor equipped with speed control and electric drive angular positioning connected in the rotor shaft.

6. “THERMAL MACHINE OPERATING PURSUANT TO Thermodynamic Carnot Cycle” according to claim 1 is characterized by the sensor element or rotation and angular position indication encoder to be directly or indirectly connected to the shaft.

7. “THERMAL MACHINE OPERATING PURSUANT TO THERMODYNAMIC CARNOT CYCLE” according to the claims 1 to 6 is characterized by servo driven rotor that is formed by the central shaft, two sets of rotor discs, a servo motor or stepper motor and the angular and rotation position sensor, allow control of the four Carnot thermodynamic transformations.

8. “THERMAL MACHINE OPERATING PURSUANT TO THERMODYNAMIC CARNOT CYCLE” according to claim 7 is characterized by servo driven rotor having two sets of discs, each occupying its respective chamber that forms the two stators system, mounted lagged, thereby allowing the control process of the thermodynamic transformations according to the differential mode Carnot cycle.

9. “THERMAL MACHINE OPERATING PURSUANT TO THERMODYNAMIC CARNOT CYCLE” according to the claim 1 is characterized by insulating discs forming the end portions of the stators are formed by discs with rigid material streaks and inner rims not fixed to the shaft, free, and external rims fixed to the housing interconnected by streaks divided into symmetrical half circles, with all semi-circles completely filled with thermal insulating material, insulating the last heat transfer discs with the ends of the outer housing of the machine.

10. “THERMAL MACHINE OPERATING PURSUANT TO THERMODYNAMIC CARNOT CYCLE” according to the claim 1 is characterized by the discs forming the heat exchanger parts of the stators, are formed by discs with rigid material streaks and inner rims not fixed to the shaft, free, and external rims fixed to housing interconnected by the streaks divided into eight symmetrical semi circles, with four of them completely filled with thermal insulating material, two of them with hot thermal transfer plates inserted into pieces of thermal insulating material which border the rims and streaks, two of them with cold thermal transfer plates, also inserted into thermal insulating material pieces and these discs have their not isolated major faces, fully exposed to the working gas or to the insulating material faces of the rotor, according to the angular position of the thermodynamic transformations of the process.

11. “THERMAL MACHINE OPERATING PURSUANT TO THERMODYNAMIC CARNOT CYCLE” according to claim 10 is characterized by a variant of the heat exchange discs of the stators, are formed by discs with rigid material streaks and inner rims not fixed to the shaft, free, and outer rims fixed to the housing interconnected by the streaks divided into four symmetrical semi circles, with two of them with hot thermal transfer plates inserted into thermal insulation material pieces, which border the rims and streaks, two of them with cold thermal transfer plates, also inserted into thermal insulating material pieces, for machines with direct transition between the isotherms. And these discs have their not isolated major faces, fully exposed to the working gas, according to the angular position of the thermodynamic transformations of the process.

12. “THERMAL MACHINE OPERATING PURSUANT TO THERMODYNAMIC CARNOT CYCLE” according to claims 10 and 11 is characterized by having the heat exchange discs of the stators, hot and cold heat transfer plates constructed of metallic material, good thermal conductor, made of one or more circulation circuit of thermal fluid and each of these circuits has exclusive power and directly from their reservoirs or sources of heat or cold.

13. “THERMAL MACHINE OPERATING PURSUANT TO THERMODYNAMIC CARNOT CYCLE” according to claims 1, 9, 10, 11 and 12 is characterized by having a body forming a two stators system featuring two chambers formed by housing, heat transfer discs, thermal insulation discs forming the set in which allows the rotor to run the control of the four differential mode Carnot thermodynamic transformations.

14. “MACHINE THERMAL OPERATING PURSUANT TO THERMODYNAMIC CARNOT CYCLE” according to the claim 1 is characterized by having a set of valves forming a gas flow control system by which computerized electronic control unit enables control of the process transition points of the four Carnot cycle thermodynamic transformations.

15. “MACHINE THERMAL OPERATING PURSUANT TO THERMODYNAMIC CARNOT CYCLE” according to the claim 1 is characterized by having a set of sensors forming a pressure and temperature monitoring system by which computerized electronic control unit allows the identification of points for sending control signals of the valves system and the auxiliary rotor of the process of the four Carnot cycle thermodynamic transformations.

16. “MACHINE THERMAL OPERATING PURSUANT TO THERMODYNAMIC CARNOT CYCLE” according to the claim 1 is characterized by the computerized control electronics unit having analog input channels for pressure, temperature readings, digital input channels for rotation and rotor angular position reading, digital output channels for valves control, analog control signals or signals network for linear control of the pumps with a flexible program that controls the process.

17. “MACHINE THERMAL OPERATING PURSUANT TO THERMODYNAMIC CARNOT CYCLE” according to claim 1 is characterized by the driving force element for high speed machines having a turbine that operates with gas flow, whose shaft and operation are independent from rotor that operates the thermodynamic transformations.

18. “MACHINE THERMAL OPERATING PURSUANT TO THERMODYNAMIC CARNOT CYCLE” according to the claim 1 is characterized by the driving force element, for low and medium rotation machines, having a mechanical element that operates by the pressure process, pistons, whose shaft and operation are independent from rotor which operates the thermodynamic transformations.

19. “MACHINE THERMAL OPERATING PURSUANT TO THERMODYNAMIC CARNOT CYCLE” according to the claim 1 is characterized by a thermal machine operating with a thermal fluid that carries heat, which can operate with thermal sources of any nature, thermo-solar, thermo-nuclear, geothermal, by renewable fuels, fuel residues or non-renewable fuels, including heat exhausted from other machines and processes.

20. “MACHINE THERMAL OPERATING PURSUANT TO THERMODYNAMIC CARNOT CYCLE” according to claims 1 and 19 is characterized by operating with thermal sources of any nature singly or in a consortium.

21. “MACHINE THERMAL OPERATING PURSUANT TO THERMODYNAMIC CARNOT CYCLE” according to claims 1, 19 and 20 is characterized by operating with thermal sources of any nature, including the thermal energy released or ejected by other machines, high temperature gases released by turbines operating on Brayton cycle, providing Brayton-Carnot cycle combined systems.

22. “THERMAL MACHINE OPERATING PURSUANT TO THERMODYNAMIC CARNOT CYCLE” according to claims 1, 19 and 20 is characterized by operating with thermal sources of any nature, including the thermal energy released or ejected by other machines, hot vapors from the output of the last stages of the turbines operating on Rankine cycle, providing Rankine-Carnot cycle combined systems.

23. “MACHINE THERMAL OPERATING PURSUANT TO THERMODYNAMIC CARNOT CYCLE” according to claims 1, 19 and 20 is characterized by operating with thermal sources of any nature, including the thermal energy released or ejected by other machines using diesel cycle engines refrigeration fluids, providing Diesel-Carnot cycle combined systems.

24. “MACHINE THERMAL OPERATING PURSUANT TO THERMODYNAMIC CARNOT CYCLE” according to claims 1, 19 and 20 is characterized by operating with thermal sources of any nature, including the thermal energy released or ejected by other machines using Otto cycle engines, refrigeration fluids, providing Otto-Carnot cycle combined systems.

25. “CONTROL PROCESS” which controls the four thermodynamic transformations, two isothermal transformations and two adiabatic transformations in accordance with Carnot cycle is characterized by being controlled by a logic device with a program that runs sequentially and synchronously these four transformations, one high temperature isothermal transformation, where the rotor keeps the gas exposed to high temperature plates and in which the gas expands, performing work in driving force element, typically a turbine or motor, in response to the angular movement of the rotor, an adiabatic transformation, where the rotor keeps the gas exposed to the thermal insulation plates and in which the gas does not exchange heat with the environment, however, lowering its temperature, saving energy, in response to another angular movement of the rotor, a low temperature isothermal thermodynamic transformation, where the rotor keeps the gas exposed to low temperature plates and in which the gas contracts, receiving work from turbine or engine, again in response to another angular movement of the rotor, a thermodynamic adiabatic transformation, where the rotor keeps the gas again exposed to thermal insulating plates, and in which the gas does not exchange heat with the environment, but by increasing the temperature, saving energy, closing a full Carnot cycle.

26. “CONTROL PROCESS” according to claim 25 is characterized by having in the four-phases thermodynamic cycle process, two isotherms and two adiabatic regardless of the driving force mechanical cycle.

27. “CONTROL PROCESS” according to claims 25 and 26 is characterized by having in the process the working gas flow control through the electronically controlled two-way valves, opening the valves allowing the flow of gas through the driving force element during the isothermal transformation process and passing through the compressor during the adiabatic change process.

28. “CONTROL PROCESS” according to claim 25 is characterized by having in the process, the transition control of each of the four thermodynamic phases electronically, via readings signal of the pressure and temperature sensing elements, which determines to the program the respective drive times of the valves and servo controlled rotor movement.

29. “CONTROL PROCESS” according to claim 25 is characterized by having a process of four thermodynamic transformations according to the Carnot cycle, with a controllable power, modulating adiabatic and isothermal transformations, by a duty cycle type control method, allowing greater flow of energy during isothermal transformation generating more work or power, shortening the adiabatic transformations, or rather, shortening the isothermal transformations providing less work or power and increasing the adiabatic transformations phases, saving more energy.

30. “CONTROL PROCESS” according to claims 25 and 26 is characterized by having in the process the performance of electronically controlled work operating through the working gas flow from one chamber to the other cyclically, regardless of whether the driving force generator element is working by pressure or flow, such as pistons or turbine.

31. “CONTROL PROCESS” according to claim 25 is characterized by having the in process the control through control program logic routines of the four phases of the Carnot cycle as follows: in isothermal phases of the thermodynamic cycle, the program keeps static rotor exposing working gas through to hot and cold areas respectively in each chambers, allowing the gas to perform work in the engine or turbine, but the adiabatic phases occur during the transition of the rotor movement which in this case moves the gas directly from one hot zone to a cold one or vice versa in the machines that are designed without the isolated region.
